(19) United States
(12) Patent Application Publication
(10) Pub. No.: US 2015/0187008 A1
(43) Pub. Date: Jul. 2, 2015

(54) CUSTOMIZING BASKETS FOR EXCHANGE-TRADED FUNDS

(71) Applicant: BlackRock Fund Advisors, San Francisco, CA (US)

(72) Inventors: Joseph Cavatoni, Rye, NY (US); Ananth Narayan Madhavan, San Francisco, CA (US); Elya Schwartzman, Mill Valley, CA (US)

(21) Appl. No.: 14/141,719

(22) Filed: Dec. 27, 2013

(51) Int. Cl. G06Q 40/06

(52) U.S. Cl. CPC G06Q 40/06

(57) ABSTRACT

A fund management system permits an investor to transmit a custom creation basket of securities to the fund management system in exchange for shares of a fund. The fund management system receives an available basket of securities from the investor and a fund designated for share creation. The fund management system filters the available securities to determine securities eligible for inclusion in the fund management system. An optimization algorithm determines a quantity of securities that maximizes the utility of adding the securities to the fund, which generates a custom creation basket. The fund management system may receive available baskets from multiple investors and a designation of multiple funds. The fund management system thus may generate a multi-party and multi-fund optimized custom creation basket.

### BACKGROUND

This invention relates generally to creation of shares of an exchange-traded fund (ETF), and particularly to customizing baskets used for creating shares of an exchange-traded fund.

An exchange-traded fund is a fund in which shares of the fund may trade on an exchange through a trading day. The exchange is a secondary market for the fund, as ordinary investors cannot directly create or redeem shares with the fund through the exchange. Instead, shares of the ETF are created by an authorized participant interacting with the fund. In the ETF creation process, the fund manager of an ETF publishes a portfolio composition file (PCF) each business day defining a creation basket of securities that may be exchanged by an authorized participant in exchange for newly-created shares of the ETF on such business day. An authorized participant desiring to create shares of the ETF transfers the set of securities defined in the PCF in exchange for share of the ETF.

For many types of ETFs, the ETF is designed to track the performance of a specified market index. For example, an ETF may be designed to track a bond index describing bond value and performance in the United States. Market indices frequently include hundreds or potentially thousands of individual securities. The fund seeks as its investment objective to track the performance of such market index. For index tracking ETFs, the benchmark for the fund is the specified market index and the fund invests in the individual securities that are included in the index. For example, in a fund tracking an index of equities of the five hundred largest companies by market capitalization, the fund may hold equities of all five hundred of these companies or a subset of securities that seek to represent the overall performance of the index.

To track the index, fund managers of an ETF typically designate creation baskets including securities that together mimic the index, but the creation basket often does not include all securities in the index, usually making up just a portion of the index and/or other representative securities. The selected securities for the creation basket are often selected based on liquidity, expected performance, accuracy in mimicking the fund or index, and any other relevant metrics. Accordingly, if an authorized participant or investor has securities that match the benchmark for a fund, but is not in the creation basket, the investor cannot contribute those securities to create the fund. This is a particular problem in fixed income or frontier markets, where a benchmark may include a significant number of less liquid securities that are often not included in a creation basket designated by the published portfolio composition file due to accessibility concerns. In such cases, the fund manager is aware that such securities are not available by investors generally to facilitate creation activity but would otherwise be appealing to the fund if available by any particular investor. This also provides an opportunity for banks and broker dealers at anytime, but particularly during times of shrinking trading operations, whether voluntarily or involuntarily for such investors to unload less liquid or less accessible inventory that may be represented in a benchmark and eligible for creation activity with an ETF which otherwise would be difficult to unload without a strong market environment.

### SUMMARY

A fund management system generates custom creation baskets, where a custom creation basket may be created specifically for one or more investors for a particular ETF. The fund management system receives information about available securities and quantities of the available securities from at least one investor, such as an authorized participant or a client of the authorized participant. The fund management system also receives a designation of one or more ETFs managed by a fund manager and the fund management system. When multiple authorized participants or investors provide their available inventory, the assets in the available inventory may be pooled together to obtain a list of securities that may be used to purchase shares of the ETF. To determine if this pooling is possible, the fund management system filters the available securities according to business rules and selects eligible securities consistent with the securities listed in the fund's benchmark or investment strategy.

Using the filtered securities, the fund management system calculates an optimized basket of the eligible securities for use to create new shares of the fund. To determine the optimized basket, the fund management system selects and evaluates the candidate baskets. The fund management system determines candidate baskets from permutations of securities in the pool of eligible securities, in one embodiment.

The fund management system evaluates the candidate baskets by calculating a utility function of each candidate basket. Each candidate basket designates a set of securities and a quantity of those securities. The utility function calculates the relative benefits to the fund by determining the utility of adding of the candidate basket to the current holdings of the fund. The utility function in one embodiment determines change in value of the fund assets, change in risk, and the change in tracking error relative to the benchmark. The change in value of fund assets is determined using market analysis and may include forward-looking expectations for the performance of securities in the fund assets. Likewise, the change in risk of the fund assets includes market analysis and forward-looking expectations of the risk profile for securities in the fund assets. The change in tracking error is typically permitted up to a maximum threshold for the fund, thereby allowing addition of securities that cause some deviation from the benchmark but are expected to improve value and reduce risk of the fund.

Using the utility function, the fund management system identifies a quantity of each security in the candidate basket by determining quantities that yield a maximum utility using a utility maximizing methodology for multiple inputs, such as by a hill-climbing, random walk, or simulated annealing algorithm. The quantities are bounded by the number of each security available in the eligible securities as provided by the investors. The fund management system selects the candidate basket that yields the highest maximum utility as a custom creation basket for the fund. When evaluating multiple funds, the funds may each be associated with a utility function. A global utility function determines the global utility across the multiple funds of allocating the securities in the eligible baskets to each of the funds. The utility function for each fund may be weighed in the global utility function to preference creation of particular fund shares. The resulting custom creation basket may also be subject to fund manager approval.

After selecting the custom creation basket, the fund management system determines the respective contribution of securities for the custom creation basket from each authorized participant or investor that provided available securities. The current value of the respective contributions is determined, along with a fund share quantity that the authorized participant will receive for the respective contribution. The fund management system notifies each authorized participant or investor of the respective contribution and associated fund share quantity.

In addition to accommodating multiple investors, the investors may also designate several funds for consideration. In this case, the fund management system determines and evaluates candidate baskets relative to each fund and permits the investors to exchange the available securities for shares of more than one fund.

Embodiments of the invention thus permit a fund management system to receive less liquid and other odd-lot securities in the benchmark that may otherwise be difficult for the fund manager to acquire in creation baskets from individual investors. This also enables investors to create shares of the ETF using available securities that do not exactly match the published creation basket designated for the ETF through the PCF, and it permits the transfer of such less liquid and odd-lot securities to the fund.

### BRIEF DESCRIPTION OF THE DRAWINGS

FIG. 1 shows an overview of a process for creating a shares of an exchange-traded fund (ETF) using a customized creation basket according to one embodiment.

FIG. 2 shows an environment for a fund management system 110 according to one embodiment.

FIG. 3 shows a method of generating a custom creation basket for fund shares according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

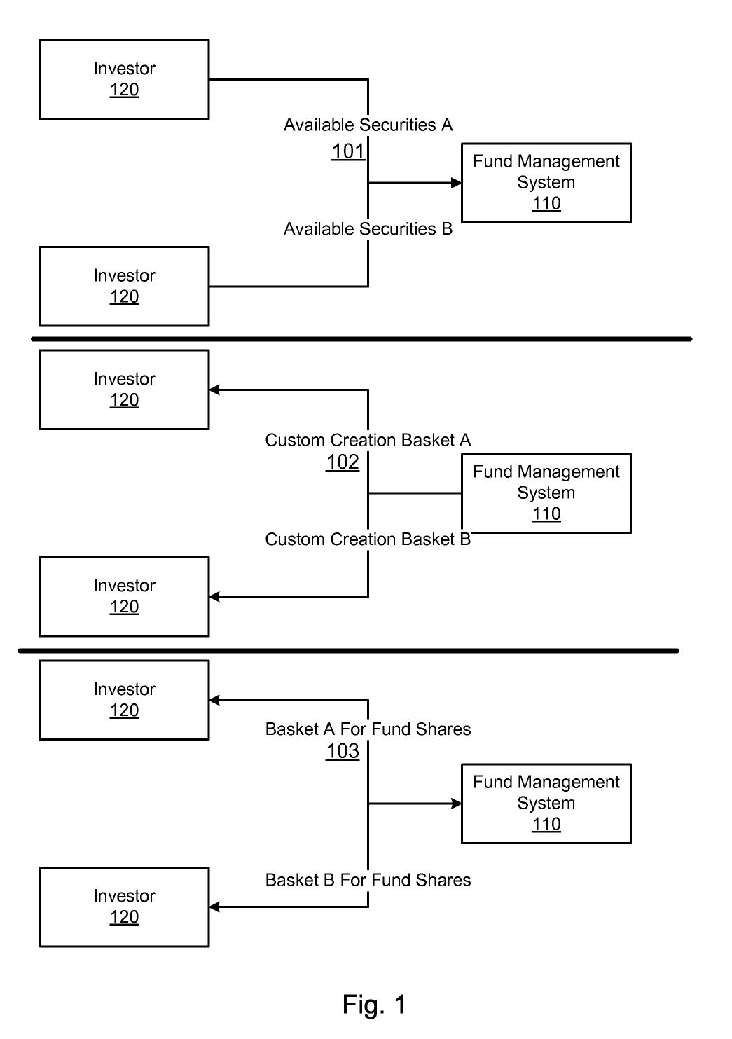

FIG. 1 shows an overview of a process for creating a shares of an exchange-traded fund (ETF) using a customized creation basket according to one embodiment. In this example, investors 120 are in communication with a fund management system 110 to exchange a customized creation basket for shares of the ETF. In this example, multiple investors 120 exchange securities which together are added to the ETF holdings. The investors 120 each provide 101 a set of available securities to the fund management system 110. The set of available securities designates securities and a quantity of the securities available from the investor 120 to create shares of the fund. The fund management system 110 evaluates the available securities with respect to holdings of the fund and determines a custom creation basket of shares from each investor 120 that may be used to create shares of the fund. The custom creation baskets are transmitted to each respective investor 120. The investor 120, if the custom creation basket is agreeable to the investor 120, transfers the securities designated in the custom creation basket and in turn receives 103 shares of the fund from the fund management system.

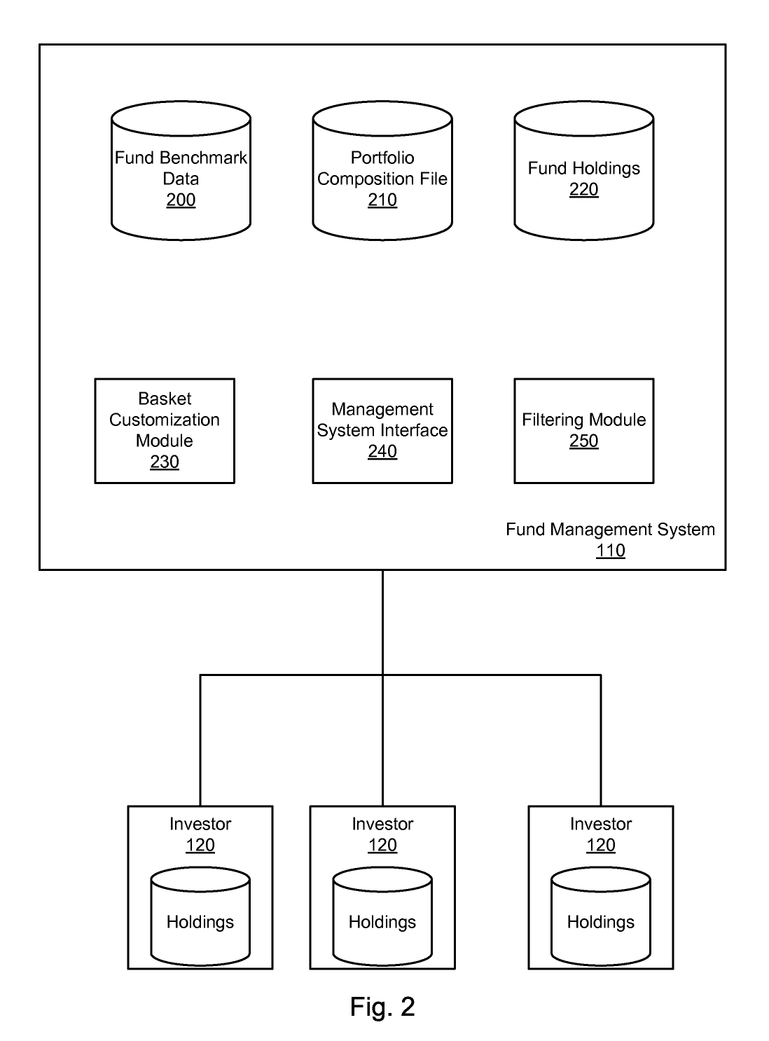

FIG. 2 shows an environment for a fund management system 110 according to one embodiment. As shown in FIG. 1, fund management system 110 is in communication with a plurality of investors 120. The fund management system 110 may be in communication with the investors 120 using any suitable communication channel, such as a direct communication channel, a financial network, an unspecialized network, or any other suitable means of communication.

For convenience of description, any terms relating to creation, transfer, or other management functions with respect to securities or shares may be performed by an appropriate financial system. For example, the transfer of securities from the investor 120 to the fund management system 110 may in-fact be performed by re-assigning beneficial ownership of the securities at a third-party, not shown here. As another example, an entity having or “holding” securities may in fact be a beneficial interest maintained or registered at a third party.

The investors 120 each maintain a set of holdings that may include any assets. The investor 120, as used in this disclosure may refer to an entity making inventory available and exchanging a customized basket with the fund management system. These investors include authorized participants qualified to create or redeem ETF shares directly with the fund management system 110 as well as other investors that may create shares of the fund indirectly through an authorized participant. These other investors include, for example, clients of an authorized participant and any other entity or person that exchanges securities with the fund indirectly. Each investor 120 maintains ownership of a set of holdings. These holdings may include any assets, such as stocks, bonds, notes, contracts, and any other financial instruments.

To receive a customized creation basket from the fund management system 110, the investor 120 selects an available inventory of securities and a quantity of the securities from the holdings of the investor. The available inventory may be all of the investor's holdings, or may be a portion thereof. The investor 120 selects which inventory is to be made available in any manner, which includes automated selection or manual selection by an operator. The investor 120 transmits the available inventory to the fund management system 110. The investor 120 also designates a fund or multiple funds that the investor 120 would be willing to receive in exchange for the securities in the available inventory. The investor 120 may also transmit available inventory with certain characteristics (tracking error, sectors, etc.) and request that the fund management system designate funds or multiple funds that reflect the same or similar characteristics as the available inventory.

After being notified of a custom creation basket from the fund management system, the investor 120 determines whether to use the custom creation basket for a creation transaction, subject to fund approval on the date of the request. The notification may be performed automatically or manually by the operator of a system of the investor 120. The custom creation basket designates which ETF (or several) and in what quantities will be received in exchange for the custom creation basket. If accepted by the fund, the investor 120 transmits the securities designated in the custom creation basket to the fund. In return, the investor receives shares of the ETF(s) designated by the custom creation basket from the fund.

The fund management system 110 includes a variety of modules and data stores for generating custom creation baskets. For each fund, the fund management system maintains fund benchmark data 200, a portfolio composition file 210 (PCF) and fund holdings 220. The fund management system 110 in this embodiment maintains a basket customization module 230, a management system interface 240, and a filtering module 250. Functions of these modules are separately designated in this disclosure for ease of description, and in various systems these functions may be performed by more or fewer modules and other components.

Fund holdings 220 is a ledger indicating current holdings of the fund. The fund holdings 220 designate a quantity of each security in the fund, and may represent expected transactions that have not yet settled.

Fund benchmark data 200 maintains data designating particular securities that are eligible for inclusion into the fund holdings 220. In certain funds, the fund is designed to track an index defined by particular securities. The benchmark may also designate a particular quantity of each security. For example, the benchmark for a fund designed to mimic a capitalization-weighted set of stocks designates a quantity of stocks for each the set of stocks to yield the capitalization weighting. The fund benchmark data 200 may also designate a future benchmark for the fund. The future benchmark indicates the expected state of the benchmark, such as after removal of a particular security or addition of another, or an expected change in the composition of the benchmark by re-weighing the components of the benchmark.

The fund benchmark data 200 typically specifies more securities than are actually held by the fund holdings 220. The fund holdings 220 are selected by the fund manager to mimic the performance of the fund benchmark data 200, but may not include all securities in the fund benchmark data 200 or in the quantities designated by the fund benchmark data 200. A tracking error defines the difference in expected performance between the securities in the benchmark data 200 and the fund holdings 220.

The portfolio composition file 210 (PCF) designates a published creation basket for the fund. The creation basket designates a set of securities and quantity of securities that may be exchanged by any investor for shares of the fund on a particular business day. The fund management system 110 publishes the PCF 210 and permits an investor 120 to exchange the creation basket of securities designated in the PCF 210 for shares of the fund. The fund management system 110 typically selects securities for inclusion in the portfolio composition file 210 based on the availability of the securities, inclusion in the fund benchmark data 200, expected performance, and so on. The portfolio composition file 210 is published publically and available for any authorized participant to initiate a transaction. An investor who is not an authorized participant may initiate the transaction through an authorized participant. Because the PCF is published publically for any authorized participant, the PCF typically does not include all securities listed in the fund benchmark data 200 and may be based on a pro rata portion of the fund holdings 220. The PCF 210 often excludes less liquid securities or other securities that may be held or accessible by investors 120 and may be beneficial for the fund.

The basket customization module 230, management system interface 240, and filtering module 250 work in conjunction to permit investors 120 to exchange customized baskets that differ from the PCF 210 and receive shares of the fund. In addition, the customized baskets permit multiple investors 120 to exchange securities for multiple ETFs, as described further below. As an example, a first investor may receive a customized basket designating a set of securities to exchange for 6,000 shares of fund A and 4,000 shares of fund B, while a second investor receives a second customized basket designated a different set of securities to exchange for 4,000 shares of fund A and 6,000 shares of fund B. The first and second investor, alone, may have none of the securities required for either fund A or fund B, but together custom creation baskets are generated to permit trade multilaterally across multiple funds.

The Management System Interface 240 is an interface through which the investors 120 communicate with the fund management system 100. The investors 120 provide the available securities to the management system interface 240. Management system interface 240 provides available baskets to the filtering module 250 to determine which securities in the available inventory are available for inclusion into designated funds. The management system interface 240 also transmits custom creation baskets to the investors 120 or indicates that no custom creation basket was available. The management system interface 240 manages receipt of securities designated in the custom creation basket and the creation and distribution of fund shares upon receipt of the creation basket securities.

Filtering module 250 receives the available baskets from the management system interface 240 and determines which of the securities in the available baskets are eligible for inclusion into the designated funds. The filtering module 250 filters, or screens, the securities in the available basket(s) based on rules associated with the fund. Initially, the filtering module 250 removes securities that are not in the applicable fund benchmark data 200 (current or forward) or in the published creation basket (PCF) for the fund. Next, additional business rules may be applied based on the fund. As example rules, the filtering module 250 may exclude securities that were recently sold by the fund, securities in a redeem basket of the fund, securities with a corporate action outstanding, securities under a minimum maturity date, and so forth. The remaining securities are securities eligible for inclusion into the fund. In one embodiment, the list of securities that were filtered and the reason the securities were filtered is displayed to an operator of the fund management system 110. The operator may designate that a security is eligible despite failing a filter. The filtering module 250 passes the eligible securities to the fund customization module 230.

The basket customization module 230 determines a custom creation basket using the eligible securities. For each fund designated by the basket of available securities from an investor 120, the basket customization module 230 pools the eligible securities to determine, for each fund, a pooled basket of securities eligible for inclusion into the fund. The pooled basket includes the securities from each investor 120 that provided available securities, as filtered to include securities eligible for inclusion into the fund. The basket customization module 230 performs the same for any additional funds designated by the investors 120. For each fund, the basket customization module 230 determines an optimized basket for addition of eligible securities to the fund.

To determine the optimized basket for a fund, the basket customization module 230 generates candidate baskets. The candidate baskets in one embodiment are generated by considering each permutation of eligible securities as a candidate set of securities for inclusion to the basket. In one embodiment, rather than generate a plurality of candidate baskets, one candidate basket comprising all eligible securities for the fund is used.

Each of the candidate baskets is evaluated to determine an optimal quantity of each security in the candidate basket for use in creating shares of the fund. To determine the optimal quantity of each security, quantities of the security are evaluated using a utility function. The utility function evaluates whether the addition of the eligible securities to the fund positively impact the fund relative to the fund assets without the inclusion of the eligible securities. The utility function positively incorporates the attractiveness of the securities based on a fund-specific attractiveness measure, and negatively incorporates the risk associated with the securities. The attractiveness of the securities is reduced based on the transactional cost, expected performance of the securities, liquidity of the securities, and other information known or assessed by the fund management system 110. The expected performance of a security may include forward-looking expectations for performance of the fund and market analysis performed by the fund management system 110 or analyst views incorporated into the fund management system 110.

As the candidate baskets are evaluated, the quantities of each security are adjusted to determine the maximum utility of the candidate basket. The evaluation of the candidate basket is also constrained by the number of securities actually available from the investors 120. In addition, the evaluation of the candidate basket is performed relative to a tracking error from the benchmark for the fund. That is, the inclusion of the candidate securities cannot exceed a maximum tracking error of the fund. The candidate basket may also be constrained by limiting the over or under-weight of a particular security, security type, sector, issuer, or other categorization of the security, even if the tracking error from the benchmark is not violated. Thus, the candidate basket is maximized subject to controlling risk to the fund and within the maximum permissible tracking error for the fund. In maximizing the utility of the fund, any suitable method for maximizing a value (the utility function) based on a combination of inputs (quantity of each security) is used. For example, the optimization may be performed using hillclimbing, random walk, simulated annealing, or any other suitable technique. Thus, for each candidate basket, an optimum quantity of each security (constrained by availability) is determined along with an associated utility. The candidate basket with the highest utility is selected as the candidate basket for use in the customized creation basket. The quantities of each security that yielded the highest maximum utility is selected.

In one embodiment, the utility is maximized using a formula shown in Equation 1:

Maximize {α·(h−h_{B})−λ_{S}(h−h_{B})V_{S}(h−h_{B})−λ_{F}(h−h_{B})V_{F}(h−h_{B})} Equation 1

Wherein:

α is a measure of attractiveness of a security from a fund performance viewpoint, which may incorporate transaction costs and liquidity of the security,

h is the fund holdings after inclusion of the candidate securities

h_{B} is the fund benchmark (a vector of dimension n×1 for the n assets in the fund),

V_{S} is a specific risk model (a matrix of dimension n×n),

V_{F} is a factor risk model (a matrix of dimension n×n),

λ_{S} is specific risk aversion measure, and

λ_{F} is factor risk aversion measure.

The factor risks incorporate risks that reflect systemic risk, such as a change in interest rates. The specific risks incorporate risks that reflect risks specific to individual securities, such as default risks. These risks may vary, for example, if each risk model incorporates different measures of confidence in the risk measurements. In one embodiment, Eq. 1 may be generalized to consider a single risk model and risk aversion measure.

In another embodiment, the utility is maximized using a formula shown in Eq. 2:

Maximize {α·(h−h_{B})} Equation 2

given the tracking error is maintained below a maximum threshold, as shown in Eq. 3:

(h−h_{B})V_{F}(h−h_{B})+(h−h_{B})V_{S}(h−h_{B})≦ε Equation 3

wherein ε is the maximum allowable tracking error.

Using the selected candidate basket and the quantity of desired securities, the basket customization module 230 generates custom creation basket for each investor 120 according to the availability and quantity of securities designated in the respective available basket from each investor. The custom creation basket specifies a set of securities and a quantity of those securities that differs from the creation basket specified in the PCF 210. In addition, the custom creation basket designates which fund(s) shares may be eligible for creation activity by the investor 120.

In one embodiment, the basket customization module 230 determines the customized baskets for more than one fund at once to optimize contribution of securities across multiple funds. In this embodiment, the basket customization module 230 is also optimizing the contribution of securities from the investors to multiple funds. To determine this optimization, a utility function is generated for each fund using fund-specific evaluations, and a global utility function incorporates the utility functions of each fund. In one embodiment, the utility functions of each fund are combined using weights, such that the global utility function preferences funds based on the weighting. Such weighing may be performed, for example, by a fund manager desiring to increase liquidity of a fund by preferencing creation of additional shares of that fund. The allocation of securities to each fund is treated as an additional input and varied in determining the maximum global utility of the utility maximization limited by the number of securities designated as available by the investors 120. The investor designation of funds may also limit the number of securities allocable to each fund. For example, a first investor designating fund A, and a second investor designating fund A or B and making the same securities available will permit additional securities to be considered for fund A due to the availability of securities from the first investor for that purpose.

After creation of the custom creation baskets, the custom creation basket is transmitted to the respective investors through the management system interface 240. In one embodiment, prior to transmitting the custom creation baskets, a fund manager review and approves the custom creation baskets.

Using this system, a fund management system 110 can automatically generate custom creation baskets for one or multiple funds from a list of available securities received from one or multiple investors 120. Upon acceptance by the funds and transmittal of the securities designated in the creation baskets by the investors, the fund management system 110 creates shares of the designated fund and transmits the fund shares to the investors 120.

In one embodiment, the fund manager maintains a record of custom creation baskets accepted by a fund. The performance of the securities provided by the investors is tracked to determine if the securities provided by the investor significantly and negatively deviate from the expected performance of securities held by a fund as a whole. In another embodiment, the performance of the securities provided by the investors are evaluated against the PCF to measure quality and any negative deviation or shortfall in performance among the custom basket, the published PCF and the fund's net asset value. When there is such a deviation, the fund management system 110 identifies that investor 120 as likely providing securities as available which underperform. The fund management system develops scorecards to detect systematic deviations for each investor. If the investor consistently produces negative scores from use of custom baskets, the investor may be excluded from providing available baskets for use in future custom creation baskets.

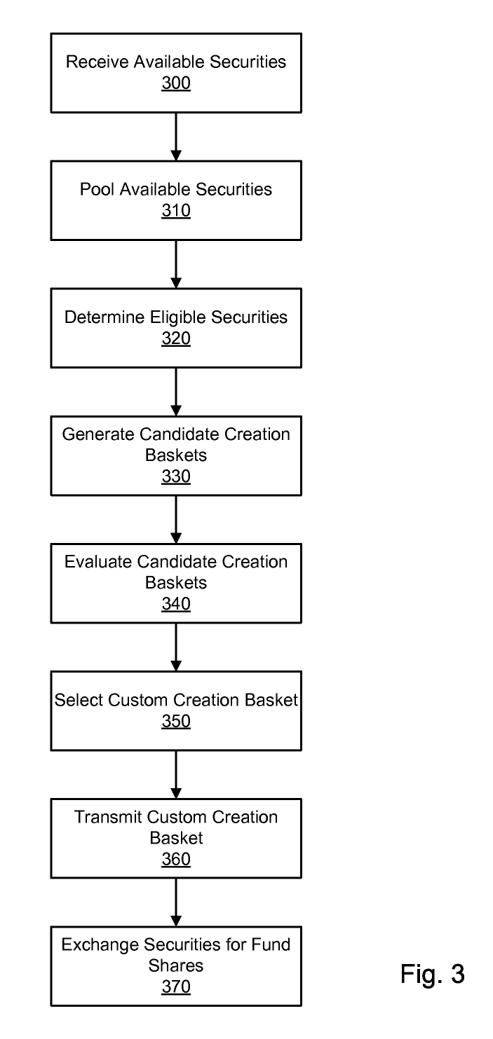

FIG. 3 shows a method of generating a custom creation basket for fund shares according to one embodiment. This method is performed in one embodiment by components of fund management system 110. Initially, the system receives 300 available baskets of securities from at least one investor designating possible funds to be created. Next, the available baskets of securities are pooled 310 to determine the total securities available for inclusion in a custom creation basket. Next, the available securities are filtered to determine 320 eligible securities that meet applicable fund benchmarks or strategies and satisfy various business rules for securities to be included in the designated funds.

Candidate sets of eligible securities to be included in a custom creation basket are generated 330, and those candidate creation baskets are evaluated 340 by a utility function, such that the quantity of each security in the candidate creation basket that maximizes the utility of the candidate creation basket are determined. From the optimized candidate creation baskets, the candidate creation basket having the highest utility and satisfying various requirements, such as deviation from a tracking error, are selected 350 as the custom creation basket. The custom creation basket is transmitted 360 to the investor(s) and if securities designated by the custom creation basket are accepted by the fund, they are exchanged 370 for fund shares. When multiple funds are designated, a global utility function weights the utility function of allocating available securities among each of the funds, which may be weighted according to the desirability of creating shares of a particular fund, or by other factors. While described in this particular order, the steps shown in FIG. 3 may be performed in alternate orders, for example, the eligible securities may be determined for each available basket prior to pooling the securities.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for generating a customized basket for an exchange traded fund (ETF), the method comprising:
receiving, from an investor available inventory of securities designating securities and quantities of the securities available for use in creation of shares of the ETF;
selecting, by a fund management system, a set of eligible securities from the available inventory based on whether the available securities matches securities in a benchmark or strategy associated with the ETF;
generating, by the fund management system, a custom creation basket including securities and a quantities of the securities in the set of eligible securities, the customized basket determined based on optimizing a utility function relative to current assets of the ETF fund and a benchmark of the ETF fund, the utility function positively measuring value to the ETF fund and negatively measuring risk to the ETF fund;
transmitting the custom creation basket to the investor; and
responsive to receiving the securities and quantities of securities in the customized basket from the authorized participant, creating shares of the ETF fund and transmitting the shares of the ETF fund to the investor.

2. The method of claim 1, wherein the custom creation basket differs from a creation basket published in a portfolio composition file defining a creation basket exchangeable for shares of the ETF.

3. The method of claim 1, wherein the eligible securities are further selected based on business rules specific to the ETF.

4. The method of claim 1, wherein optimizing the utility function includes maintaining a tracking error of the fund less than a maximum tracking error.

5. The method of claim 1, further comprising generating a plurality of candidate baskets comprising candidate sets of securities in the eligible basket, each candidate basket including a different set of securities; wherein generating the custom creation basket comprises evaluating the candidate baskets

6. The method of claim 1, further comprising receiving, from another investor, another available basket of securities; and pooling the available basket and the other available basket; and wherein the set of eligible securities is determined based on the pooled available basket.

7. The method of claim 1, wherein the investor designates the available basket is available for creation of shares of a plurality of ETFs, and wherein generating a custom creation basket comprises determining a creation basket for more than one of the plurality of ETFs; and wherein the custom creation basket is generated based on a global utility function based on a utility function associated with each of the plurality of ETFs designated by the investor.

8. The method of claim 7, wherein the global utility function weighs the utility function associated with each of the plurality of ETFs.

9. The method of claim 1, wherein the benchmark associated with the ETF comprises bond securities.

10. The method claim 1, wherein the investor is an authorized participant.

11. The method of claim 1, wherein the investor interacts with the fund management system through an authorized participant.
